(19) United States
(12) Patent Application Publication
(10) Pub. No.: US 2007/0116799 A1
(43) Pub. Date: May 24, 2007

(54) Chewable mass for the remineralization of tooth enamel

(76) Inventor: Jobst Lahrsow, Tauberbischofsheim (DE)

Correspondence Address: ROBERT W. BECKER & ASSOCIATES, 707 HIGHWAY 333, SUITE B, TIJERAS, NM, 87059-7507, US

(21) Appl. No.: 10/576,151

(22) PCT Filed: Sep. 28, 2004
(86) PCT No.: PCT/EP04/10860

§ 371 Date: Jun. 28, 2006

(30) Foreign Application Priority Data
Oct. 17, 2003 (DE) 103 49 050.7

(51) Int. Cl. A23G 4/00

(52) U.S. Cl. 426/3

(57) ABSTRACT

A method of producing chewable mass for remineralization of tooth enamel, including the steps of preparing an aqueous solution of at least one acidifying agent suitable as a foodstuff, adding a reactive calcium source to the aqueous solution, adding the solution to a thickener, wherein phosphoric acid is added during at least one of the preceding steps, thoroughly mixing all of the components to form a mass, and forming and drying the mass. The chewable mass has a calcium content of between 30 and 190 mMol/kg of finished product.

The present invention relates to a chewing gum for the remineralization of tooth enamel, as well as to a method for the production of such a chewing gum.

Up till today the use of fluoride applies as method of choice to prevent caries or cavities, since other options such as mouth hygiene or nutritional guidance generally fail due to human slackness. Nevertheless, fluoride is only useful to a limited extent for healthy maintenance of teeth, since its main protection mechanism, promotion of the remineralization of tooth enamel, is only possible in the presence of free calcium- and phosphate-ions.

During periods in which the tooth enamel is decalcified by the acids separated from micro organisms in the oral cavity, small pores form on its surface. From these the calcium salts migrate from the bottom of the enamel into the tooth lining and then to the oral cavity. Deep pores, in which the minerals calcium and phosphate are deficient, therefore remain behind. If this decalcification is not stopped, they then cave in later with the actual caries or decay formation.

In the case of naturally occurring remineralization of the tooth enamel such pores are very quickly closed by the calcium- and phosphate-ions near the neutral point existing in the saliva just as with a cork. Deeper lying enamel layers however remain impoverished of mineral.

At this point the so-called “forced dynamic remineralization” begins. By reducing the pH level with simultaneous increase of the mineral concentration, for example by means of an acidic remineralization solution enriched with calcium and phosphates or a chewing or sucking gum prepared accordingly, the concentration of minerals in the oral cavity environment can be increased several times, without the saturation point being substantially exceeded. As a result of such a measure the porous, decalcified tooth enamel is impregnated with mineral. In this way a large quantity of dissolved mineral is transported into all areas of the lesion.

After the application, the pH level in the environment of the tooth again rises through saliva clearance, but at the same time the mineral concentration there falls drastically. Both protons and some of the mineral inwardly dispersed during the application again diffuse back into the mouth cavity out of the porous enamel area. Because of the greater mobility of the hydronium (H+) ions and the non-linear correlation between diffusion time and extent, the area near the surface becomes impoverished of mineral faster than the deeper lying layers. The mineral is trapped in these because of the greater mobility of the hydronium ions and after their removal—on account of the rise in pH caused as a result—is deposited on the pore walls. In this way both place and quantity of the mineral entrapment are influenced positively through the temporary concentration profile, which is predefined by the application.

Fruit gum, which contains an addition of calcium in the range of 3 mMol/kg, is well known from practice. This concentration is too low for preventing the formation of caries.

A possible way to produce the aforementioned temporary concentration profile in the oral cavity is through chewing gum, particularly in the form of fruit gum, which is enriched with calcium and phosphate. Such chewing gum is described in European Patent EP 0 648 108 B1 in a general way regarding the concentrations of calcium and phosphate together with other exemplary embodiments. There it is proposed that a concentration of calcium in the chewing gum be adjusted between 200 mMol/kg and 800 mMol/kg and that of phosphate in the range of 50 mMol/kg and 400 mMol/kg. A production process for such a chewing gum is not disclosed.

U.S. Publication 2001/0033831 A1 proposes the addition of a tri-calcium phosphate in remineralizing chewing gum. Although a tri-calcium phosphate is more soluble than the other neutral and basic calcium phosphates, an effective remineralization effect exceeding that of saliva is not to be expected.

The implementation of calcium and phosphate from the calcium salts of the fruit- or carboxylic acids and phosphates does not provide the desired results. Although a product, in which calcium phosphate is added, is known from U.S. Pat. No. 5,015,628, the necessary concentration of calcium, which is available for the remineralization process, is too low.

A similar product is also not on the market. The problems in production are not solved by the state of the art, in particular not for chewing gum on a gelatin basis.

As is well known, Ca-ions affect the thickening reaction of gelatin in a negative way. Calcium can lead to turbidity of the gelatin used for fruit gum even as far as its coagulation. If the calcium usually in the form of salts is added together with sugar, coloring, flavoring agents etc., the threshold for turbidity of the gelatin is approximately 5 mMol/kg. For saleable products however a highly transparent, homogeneous consistency of the gelatin is always preferred.

The object to be achieved now consists of introducing calcium and phosphate in suitable modification as well as sufficient quantity into the production process of chewing gum (in particular fruit gum) so that the finished product corresponds to the requirements in effectiveness, without the taste and transparency of the gum or the “tactile feel between the teeth”, that is to say the bite or chewing feel of the finished product, being impaired. It is also an object of the invention to create a chewing gum having good effect with reduced concentrations of calcium and phosphate.

These objects are achieved by a method comprising the features of Claim 1 and by a chewing gum comprising the features of Claim 6.

Because with the inventive method for the production of a chewing gum for the remineralization of tooth enamel the following steps are proposed:
a. preparation of an aqueous solution of at least one acidifying agent, certified according to the foodstuff law, for example from the group of carboxylic acids, in particular fruit acids, and phosphoric acid;
b. addition of a reactive calcium source, for example calcium hydroxide;
c. addition of thickener, for example gelatin present in a ground or swollen state, to the solution;
d. thorough mixing of the components;
e. forming of the gum and drying, for example in corn starch molds.
   a transparent and homogeneous chewing gum with the desirable properties as regards caries prevention and for influencing initial caries is obtained. The product made by this method is distinguished by particularly good transparency and homogeneity.

The thickening agent can contain some of the flavorings and adjuncts. These however can also be added separately to the solution.

The phosphoric acid can also be added between steps (b) and (c). Likewise it is possible to add the coarsely ground thickening agent to the solution and allow it to swell there.

Because with a chewing gum according to Claim 7 it is proposed that the calcium content is between 30 mMol/kg and 190 mMol/kg (1.4 g/kg to 9.0 g/kg) related to the finished product, a long-term stable product which can be produced simply, but which exhibits a good effect in vivo, is available. This effect is achieved due to the fact that the local concentration is particularly high due to the chewing gum adhering on the tooth surface, and saliva-conditioned removal of calcium and phosphate ions does not take place to a significant degree in the contact area between the chewing gum and the tooth. In particular the phosphorus content can lie between 15 mMol/kg and 500 mMol/kg with this calcium concentration.

Particularly good properties result in the case of a chewing gum adhering on the upper surface of the tooth if the calcium content is between 50 mMol/kg and 150 mMol/kg (2.3 g/kg to 7.0 g/kg) related to the finished product.

For the forced remineralization to function well, the calcium and the phosphate should be present in the fruit gum as fully dissolved as possible, that is to say it should be present as far as possible in ion and/or colloidal form but not crystalline as salt.

The method is designed to be incorporated as optimally as possible into the conventional process for the production of fruit gum. In this case the respective thickener, for example gelatin, is allowed to swell in some of the liquid, which can also contain some of the adjuncts and additives. The swollen thickening agent, designated below as “part 1”, is then carefully mixed, avoiding bubbles, with the remainder of the ingredients (the residual water, sugar, acid, flavoring and coloring agents as well as the calcium and phosphate), designated below as “part 2”, to form the fruit gum, is dried in corn starch molds, and then further processed, for example waxed etc.

If for example calcium and phosphate are mixed in the conventional way from salts into the solution part 2, the gelatin always becomes lumpy, particularly severely in the case of the calcium lactic acid phosphate buffer.

The transparency and homogeneity of the product as well as its remineralizing capacity can be additionally controlled by the suitable mixture of various acidifying agents as components for part 2. In particular the relevant properties of the chewing gum can be controlled by varying the acid proportions with differing calcium complexing ability.

Mixing of malic acid or citric acid into a fruit gum, which is conceived on pyruvic acid for example, leads to particularly clear fruit gum mixtures having a pleasant level of acidity with good effectiveness.

### RECIPES AND EXAMPLES

In the following examples pure water is used for swelling. The swelling time of the sheet gelatin varies between 1 hour and 24 hours at temperatures between 37° C. and 60° C. (part 1).

Components from part 2, which do not disrupt the swelling reaction of the gelatin, can also be added to part 1.

Base materials are the carboxylic acids and phosphoric acid dissolved in the liquid phase of part 2 in a concentration suitable for forced remineralization and as reactive calcium source: calcium oxide, calcium hydroxide, calcium carbonate or a mixture thereof. The quantity of phosphoric acid depends on the desired phosphate concentration of the finished product and lies in the range of 15 mMol/kg to 500 mMol/kg (1.4 g/kg to 48 g/kg) related to the finished product. In the examples cited a content of 70 mMol/kg phosphate is not exceeded, although a higher phosphate content would additionally reinforce the effect. This restriction takes into consideration the German foodstuff law valid at the time of the patent application. The fruit or carboxylic acid concentration depends on the desired calcium content, pH level and the taste of the chewing gum.

Related to the finished product the calcium content lies between 30 mMol/kg and 600 mMol/kg (1.2 g/kg and 24 g/kg). The neutralization reaction shows a strong positive thermal effect so that the usual additional heating up to accelerate the reaction process can be dispensed with. In the concentrations of acidifying agent, phosphate and calcium, cited in the examples, these solutions are stable over a long time.

The examples detailed in the following are possible embodiments of the invention.

The following materials were used as additives:

| Gelatin: | Sheet gelatin from Dr. Oetker; |
|---|---|
| Ca(OH)₂: | Merck 2047; |
| Ortho-phosphoric acid 85%: | Merck 1.00563; |
| Citric acid: | Merck 8.18707; |
| Malic acid: | Merck 1.00382; |
| Pyruvic acid: | Merck 8.20170 |

The following recipes give a yield of approx. 65 g.

The entire gelatin is always pre-swollen in 15 ml distilled water for 12 hours at approx. 50° C.

The Ca-concentration in the product is 200 mMol/kg, the phosphate concentration being 70 mMol/kg.

### Example 1

Part 1: 6.7 g gelatin in 15 ml distilled water.

Part 2: 10 ml malic acid (1.5 Mol/l)+10 ml citric acid (1.0 Mol/l)+0.3 ml phosphoric acid+0.9 g calcium hydroxide+20 g household sugar.

The three acids are mixed and the calcium hydroxide is added while stirring. After complete dissolving the sugar is dissolved in the solution while being gently heated and the warm gelatin solution is stirred into the solution part 2. It is then placed in the corn flour molds and allowed to dry for approx. 20 to 48 hours.

### Example 2

Part 1: 6.7 g gelatin in 15 ml distilled water.

Part 2: 20 ml citric acid (1.5 Mol/l)+0.3 ml phosphoric acid+0.7 g calcium hydroxide+20 g household sugar

Processing as in Example 1

### Example 3

Part 1: 10 g gelatin in 15 ml distilled water.

Part 2: 20 ml pyruvic acid (1 Mol/l)+0.3 ml phosphoric acid+0.7 g calcium hydroxide+20 g household sugar

Processing as in Example 1

### Example 4

Part 1: 8 g gelatin in 15 ml distilled water.

Part 2: 10 ml malic acid (1.5 Mol/l)+10 ml pyruvic acid (1.5 Mol/l)+0.3 ml phosphoric acid+0.7 g calcium hydroxide+20 g household sugar

Processing as in Example 1

### Example 5

Part 1: 8 g gelatin in 15 ml distilled water.

Part 2: 10 ml pyruvic acid (1.5 Mol/l)+10 ml citric acid (1.5 Mol/l)+0.3 ml phosphoric acid+0.8 g calcium hydroxide+20 g household sugar

Processing as in Example 1

Proof of Effectiveness

The remineralizing effect of the fruit gum described was tested in an in vitro experiment. To obtain an idea of the importance of the resultant figures and to recognize the relations between in vivo and in vitro experiments, values regarding mineral entrapment from an experiment to discover the remineralization effect of fluoride tooth pastes carried out in situ and parallel thereto in vitro, are recorded in the last six lines of the table.

The values measured in vitro and in situ are reciprocally confirmed, as a result of which transferability of the experimental designs is given.

The results show clear mineral entrapment in the specimens treated with remineralizing fruit gum. The amount of entrapped mineral varied with the calcium complexing of the individual fruit acids.

The entrapment rates found in the present experiment each related to a treatment, in the case of the remineralizing fruit gum are greater by a factor of 4 than those in the case of dental cleaning with a fluoride toothpaste.

In-vitro remineralization of decayed porous hydroxylapatite-sintered bodies with fruit gum in comparison to a popular toothpaste on the market

| | | | | Entrapment | |
|---|---|---|---|---|---|
| | | Entrapment | | rate in | |
| | | absolute in μg | | μg per application | |
| Acid | pH | Trial 1 | Trial 2 | Trial 1 | Trial 2 |
| in vitro: | | | | | |
| Malic acid | 4.4 | 680 | 650 | 136 | 130 |
| Citric acid | 4.2 | 310 | 420 | 62 | 84 |
| Pyruvic acid | 4.4 | 1760 | 2090 | 352 | 418 |
| Lactic acid | 4.4 | 1960 | — | 392 | — |
| Malic acid/citric acid | 4.2 | 430 | 870 | 86 | 174 |
| Control (saliva) | 6.5 | −300 | −50 | −60 | −10 |
| Control (only placebo | 4.3 | | −80 | | −16 |
| fruit gum without Ca/PO₄) | | | | | |

In Vitro:

| | |
|---|---|
| MFP toothpaste | 101 |
| Placebo toothpaste | −7 |

In Situ:

| | |
|---|---|
| MFP tooth paste | 79 |
| Placebo toothpaste | 38 |

1-10. (canceled)

11. A method of producing a chewable mass for remineralization of tooth enamel, including the steps of
preparing an aqueous solution of at least one acidifying agent that is suitable as a foodstuff;
adding a reactive calcium source to said aqueous solution;
adding the solution to a thickener, wherein phosphoric acid is added during at least one of said preparing and adding steps;
thoroughly mixing all components to form a mass;
shaping said mass; and
drying the mass.

12. A method according to claim 11, wherein said thickener is gelatin in a ground or swollen state.

13. A method according to claim 11, which includes mixing various acidifying agents as a reactant for said preparing step.

14. A method according to claim 11, wherein said at least one acidifying agent comprises at least one of the group consisting of carboxylic acids and fruit acids.

15. A method according to claim 14, wherein said carboxylic acids include lactic acid.

16. A method according to claim 14, wherein said fruit acids include pyruvic acid, citric acid and malic acid.

17. A method according to claim 11, wherein said aqueous solution of said preparing step contains a calcium-complexing acid, and wherein a further calcium-complexing acid is added to such aqueous solution that is more powerful than is said first calcium-complexing acid.

18. A method according to claim 17, wherein said further calcium-complexing acid is malic acid or citric acid, and wherein said first calcium-complexing acid is pyruvic acid.

19. A method according to claim 11, wherein said calcium source is at least one of the group consisting of calcium oxide, calcium hydroxide and calcium carbonate.

20. A chewable mass produced by the method of claim 11.

21. A chewable mass for remineralization of tooth enamel and comprising a calcium content of between 30 and 190 mMol/kg (1.4 to 9.0 g/kg) of finished product.

22. A chewable mass according to claim 21, which comprises a phosphoric acid content of between 15 and 500 mMol/kg of finished product.

23. A chewable mass according to claim 21, wherein said calcium content is between 50 and 150 mMol/kg of finished product.
